(19) United States
(12) Patent Application Publication
(10) Pub. No.: US 2007/0029781 A1
(43) Pub. Date: Feb. 8, 2007

(54) Map made of synthetic paper with a spine - description

(76) Inventor: Kaj Berndtson, Schoengeising (DE)

Correspondence Address: Kaj Berndstson, Enterbruck 11, Schoengeising, D-82296, DE

(21) Appl. No.: 11/473,074

(22) Filed: Jun. 23, 2006

(30) Foreign Application Priority Data
Jun. 24, 2005 (DE) 20 2004 010 170.2

(51) Int. Cl. G09B 29/00

(52) U.S. Cl. 283/34

(57) ABSTRACT

A map, having a printed sheet of synthetic paper or synthetics, optionally having a lamination or lining on one or both sides and having fanfold lines extending in one direction. One laminar cross fold or at least two cross fold lines extend perpendicular to the fanfold lines, and is/are centred on the map sheet and form a laminar map spine. The intervals between the cross fold lines have a minimum of 1 mm and and a maximum of 25 mm. The fold lines are predefined by grooving. Optionally the laminar map spine is formed with a flat component by heating up to 40° C. to 200° C. and deformation, and remains permanent when cooled down. This map spine can bear a short information about the contents of the map.

The invention relates to a known map or an inventive map, as e.g. a country map, a road map, a street map, a city map, a hiking map, a bike map, a mountain bike map, motor cycle map, a public transport map, a nautical chart, a aviation chart, a pilotage chart, a geological chart, a architectural plan, but also an informational sheet, which is printed on a large sheet and is afterwards folded like map to a small and easy manageable format and an otherwise printed map sheet.

The “known map” has various embodiments, whereas those are predominant where the map sheet is made of printed paper, card, synthetic paper or synthetics. Such maps produced from the first two materials ware comparably fast. For said reason, maps are known where the map sheet is finished by coating or lining/lamination on one or both sides with an applied transparent plastic film. Said map sheet is folded machine-made or by hand to a smaller and easier manageable format. It's considered standard of technology, that printed map sheets made of paper, card, synthetic paper or synthetics are embossed with grooves and afterwards are completely or partly folded machine-made. Thereby the edges of the folds are predefined by the embossed grooves. Said embossing can preferably happen before or after coating or lining/lamination with an applied transparent plastic film of the map sheet with a paper weight of more than 80 g/m², and can show numerous parallel or perpendicular grooves. The cover is printed either on the outer map surfaces of the finally folded map sheet or a separate cover made of printed paper/card synthetic paper or synthetics, which is if applicable finished by coating or lining/lamination with an applied transparent plastic film on one or on both sides and is glued permanently or temporarily, laminar, spot bond or with a flap and with an appropriate glue to the finally folded map sheet. The cover of a known map is printed with an information about the contents of the map. Between both cover pages if applicable a map spine is formed, a narrow, also bent surface, which connects the front and back page of the cover and has printed on a short information about the contents of the map. All said known maps have in the finally folded format and manufactured condition a rectangular format in different physical sizes. Such known maps made of a map sheet from synthetic paper or synthetics do not have a map spine, always they have a pointed cross fold between the outer map surfaces and/or cover pages and therefore it's not possible to display a short information about the map on the map spine. It is an object of this present invention to provide an embodiment of map, which is obviating the above mentioned drawback and has further advantages.

To achieve these and related objects the present invention provides one embodiment of a map, particularly for a country map, a road map, a street map, a city map, a hiking map, a bike map, a mountain bike map, motor cycle map, a public transport map, a nautical chart, an aviation chart, a pilotage chart, a geological chart, an architectural plan, but also an information sheet, which is printed on a large sheet and is folded like map to a small and easy manageable format and an otherwise printed map sheet. The map consists of:
a map sheet made of printed and folded synthetic paper or synthetics, which has preferably a paper weight of more than 50 g/m²,
a separate cover made of printed paper, card, synthetic paper or synthetics, which is connected to the finally folded map sheet,
an appropriate glue
a coating or a lining/lamination with an applied transparent plastic film on the map sheet and/or the cover on one or both sides

In the embodiment of the inventive map it's provided according the invention, that the printed map sheet is made of a printed and folded synthetic paper or synthetics. The “Inventive Map” is a continuous printed map sheet made of synthetic paper or synthetics, which has preferably a paper weight of more than 50 g/m², which is if applicable finished by coating or lining/lamination with an applied transparent plastic film on one or on both sides, has one or multiple fanfolds and one or multiple cross folds in finally folded format and has optional a “cover” containing an information about the map printed on one or on both sides of the outer map surfaces. If applicable the inventive cover consists of a separate sheet made of printed and folded paper, card, synthetic paper or synthetics, which is if applicable finished by coating or lining/lamination with an applied transparent plastic film on one or on both sides and is glued permanently or temporarily, laminar, spot bond or with a flap and with an appropriate glue to the finally folded map sheet. The inventive maps have in the finally folded format and manufactured condition a rectangular format in different physical sizes. Furtheron the inventive map has an “Inventive Map Spine”, a small longish surface, which connects the front and back cover page and has printed on a short information about the contents of the map. This inventive map spine can also be located vertical between the cover pages. Both long and parallel outer edges of this inventive map spine have a minimum interval of 1 mm and maximum of 25 mm from eachother. This inventive map spine is formed by two crossfolds or a wide laminar cross fold. Furtheron this Inventive Map Spine is if applicable formed by a prior “Inventive Grooving” and followed by two cross folds and/or is formed by an “Inventive Thermal Deformation” to a wide and laminar cross fold. For the Inventive Grooving at first the map sheet and/or cover are embossed with 2 parallel grooves, which are perpendicular to the fanfolds and are preferably centered at the upper edge of the map and have an interval of minimum 1 mm and maximum 25 mm from eachother and afterwards are formed by two cross folds and/or by the Inventive Thermal Deformation the map sheet and/or the cover is formed with a flat component and followed by heating up to a temperature of 40° C. to 200° C. and afterwards by cooling down a wide laminar map spine is formed, which has a minimum width of 1 mm and a maximum of 25 mm. The thermal deformation of the laminar map spine and/or of the other folds, the pointed fanfolds and/or of the other cross folds of the final folded map are formed through the provided thermal heating and remain permanently after cooling down. The steps of the procedure of the Inventive Termal Deformation are also conducted in reverse order, i.e. first the heating then the forming and then the cooling down. Such a produced map is preferably designed for retail sales.

The coating of the map sheet, the separate cover is produced by print varnish (varnishing during printing process) or by UV-varnish (hereby the varnish is applied by a calender role and hardened UV light). Also other known coatings are considered.

The lined/laminated plastic films applied the map sheet, the separate cover, the outer package are advantageously PET films (polyethylene terephthalate film) suitable for hot lamination but may alternatively be OPP films (oriented polypropylene film) for cold lamination. Other known laminating films may be considered.

The invention therefore provides means to produce a map, which has a significant distinction from all other maps in the finally folded format and has further advantages. The Inventive Map from a map sheet made of synthetic paper or synthetics with a laminar inventive map spine has the advantage, that the short information printed on the map spine is easy readable. This is of great advantage for archiving, sales in shelves, in drawers and sales stands, as thereby only the map spine is visible there is now need to open the map for checking of its contents. A further great advantage is given through the use of a printed map sheet made of synthetic paper or synthetics. Such a produced map is waterproof and tearproof. This is of great advantage when used outdoors at humidity or wetness. Therefore it's provided, that the map has multiple characteristics of the invention.

Embodiment of a Map, an Inventive Map, which is Produced Form Map Sheet made of Printed Synthetic Paper or Synthetics

For this embodiment of a map it's inventive provided, that the “Inventive Map” printed map sheet and finally folded format has a preferably square or approximately square format. The “Inventive Map” is a continuous printed map sheet made of synthetic paper or synthetics, which has preferably a paper weight of more than 50 g/m², which is if applicable finished by coating or lining/lamination with an applied transparent plastic film on one or both sides, has one or multiple fanfolds and one or multiple cross folds in finally folded format and if applicable has a “cover” containing an information about the map printed on one or both sides of the outer map surfaces. If applicable the inventive cover consists of a separate sheet made of printed and folded paper, card, synthetic paper or synthetics, which is if applicable finished by coating or lining/lamination with an applied transparent plastic film on one or on both sides and is glued permanently or temporarily, laminar, spot bond or with a flap and with an appropriate glue to the finally folded map sheet. Furtheron this Inventive Map has an “Inventive Map Spine” a narrow and laminar surface which connects both outer map surfaces and which has printed on a short information about the contents of the map. This inventive map spine can also be located vertical between the cover pages. Both long and parallel outer edges of this inventive map spine have a minimum interval of 1 mm and maximum of 25 mm from eachother. This inventive map spine is formed by two crossfolds or a wide laminar cross fold. Furtheron this Inventive Map Spine is if applicable formed by a prior “Inventive Grooving” and followed by two cross folds and/or is formed by an “Inventive Thermal Deformation” to a wide and laminar cross fold. For the Inventive Grooving at first the map sheet and/or cover are embossed with 2 parallel grooves, which are perpendicular to the fanfolds and are preferably centered at the upper edge of the map and have an interval of minimum 1 mm and maximum 25 mm from eachother and afterwards are formed by two cross folds and/or by the Inventive Thermal Deformation the map sheet and/or the cover is formed with a flat component and followed by heating up to a temperature of 40° C. to 200° C. and afterwards by cooling down a wide laminar map spine is formed, which has a minimum width of 1 mm and a maximum of 25 mm. The thermal deformation of the laminar map spine and/or of the other folds, the pointed fanfolds and/or of the other cross folds of the final folded map are formed through the provided thermal heating and remain permanently after cooling down.

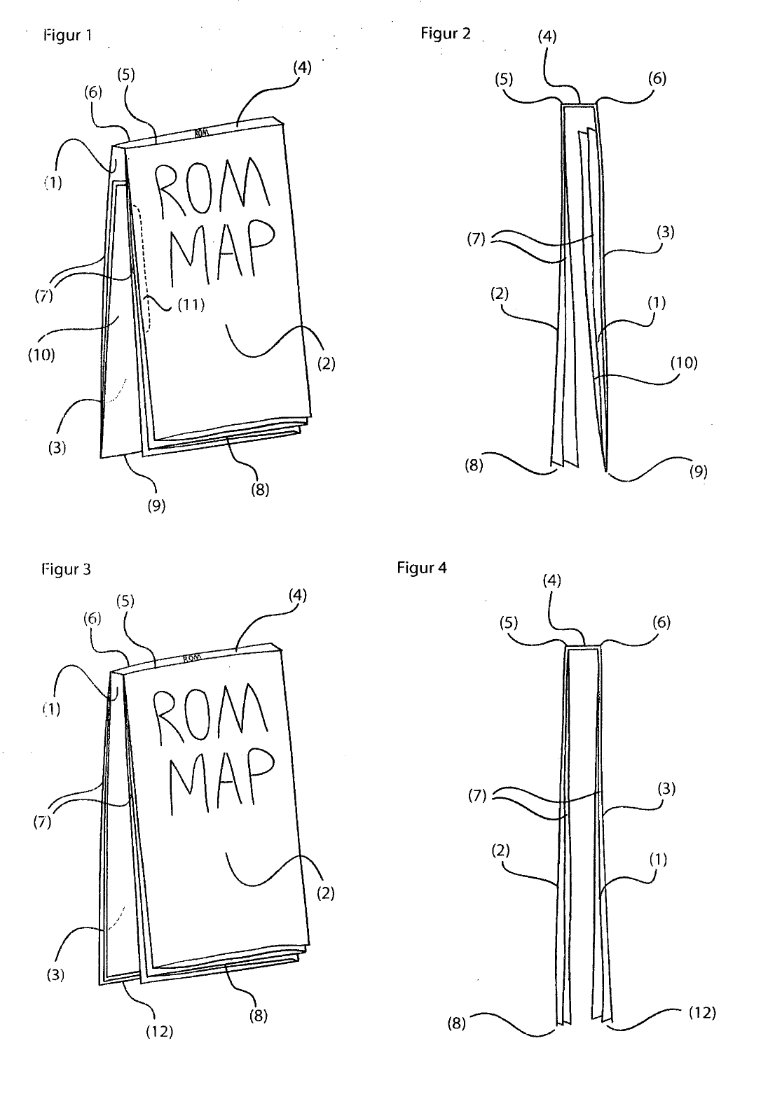

FIG. 1 shows in cavalier perspective an Inventive Map of Rom with a separate cover with a laminar Inventive Map Spine with a further cross fold at a lower edge of the map

FIG. 2 shows in side perspective an Inventive Map of Rom with a laminar Inventive Map Spine with a further cross fold at a lower edge of the map

FIG. 3 shows in cavalier perspective an Inventive Map of Rom with a laminar Inventive Map Spine

FIG. 4 shows in side perspective an Inventive Map of Rom with a laminar Inventive Map Spine

FIG. 1 shows in cavalier perspective an Inventive Map of Rom with a separate cover with a laminar Inventive Map Spine with a further cross fold at a lower edge of the map

The map sheet (1) is in the finally folded format and has a front outer map surface and a back outer map surface. The separate sheet printed with the cover image, has the front cover page (2), which is printed with the information “Rom Map” and the back cover page (3) and is connected with a flap (11) with the folded map sheet (1). Between the front and upper map edge (5) and the back and upper edge of the map (6) of both cover pages a laminar Inventive Map Spine (4) is formed, it's printed with the short information “Rom” and which is visible from the top. The folded Inventive Map has multiple vertical fanfolds (7). At the front lower edge of the map (8) the fanfold fans out and is stepped. At the back and lower edge of the map (9) through a further cross fold inwards the inner map surface (10) and a smooth back lower edge of the map is formed.

FIG. 2 shows in side perspective an Inventive Map of Rom with a laminar Inventive Map Spine with a further cross fold at a lower edge of the map

The map sheet (1) is in the finally folded format and has a front outer map surface (2) and a back outer map surface (3). Between the front and upper map edge (5) and the back and upper edge of the map (6) of both cover pages a laminar Inventive Map Spine (4) is formed. The folded Inventive Map has multiple vertical fanfolds (7). At the front lower edge of the map (8) the fanfold fans out and is stepped. At the back and lower edge of the map (9) through a further cross fold inwards the inner map surface (10) and a smooth back lower edge of the map is formed.

FIG. 3 shows in cavalier perspective an Inventive Map of Rom with a laminar Inventive Map Spine

The map sheet (1) is in the finally folded format and has a front outer map surface, the front cover page (2), which is printed with the information “Rom Map” and a back outer map surface, the back cover page (3). Between the front and upper map edge (5) and the back and upper edge of the map (6) of both cover pages a laminar Inventive Map Spine (4) is formed, it's printed with the short information “Rom” and which is visible from the top. The folded Inventive Map has multiple vertical fanfolds (7). At the lower edges of the map (8) and (12) the fanfold fans out and is stepped.

FIG. 4 shows in side perspective an Inventive Map of Rom with a laminar Inventive Map Spine

The map sheet (1) is in the finally folded format and has a front outer map surface (2), and a back outer map surface, the back cover page (3). Between the front and upper map edge (5) and the back and upper edge of the map (6) of both cover pages a laminar Inventive Map Spine (4) is formed. The folded Inventive Map has multiple vertical fanfolds (7). At the lower edges of the map (8) and (12) the fanfold fans out and is stepped.

What is claimed:

1. A map, particularly for a country map, a road map, a street map, a city map, a hiking map, a bike map, a mountain bike map, motor cycle map, a public transport map, a nautical chart, a aviation chart, a pilotage chart, a geological chart, a architectural plan, but also an information sheet, which is printed on a large sheet and is folded like map to a small and easy manageable format and an otherwise printed map sheet, comprising:
a printed and folded map sheet (1), made of synthetic paper or synthetics, and
wherein such map forms between the front upper map edge (5) and the back upper map edge (6) of the outer map surfaces (2) and (3) a laminar map spine (4), and that this has a width from 1 mm to 25 mm between both long upper map edges.

2. The map according to claim 1, and wherein the cover is printed on one or both outer map surfaces (2) and (3) of the folded map sheet (1).

3. The map according to claim 1 and a separate cover and a connection comprising:
a printed and folded sheet of paper, card, synthetic paper or synthetics, which has preferably a paper weight of more than 50 g/m²
an appropriate glue, and
wherein this separate cover is glued permanently or temporarily with an appropriate glue laminar, by spot bond or with a flap (11) to the folded map sheet (1). Such a cover forms between the front upper map edge (5) and the back upper map edge (6) of the outer map surfaces (2) and (3) and a laminar map spine (4),), and that this has a width from 1 mm to 25 mm between both long upper map edges.

4. The map according to one of the claims from 1. to 3. and wherein the map spine (4) is mounted vertical between the both outer map surfaces and/or cover pages.

5. The map according to one of the claims 1. to 4. and a finishing comprising:
a coating or a lining/lamination with an applied transparent plastic film on the map sheet and/or the cover on one or both sides and wherein the coating is a print varnish or a UV-varnish or that the lined/laminated plastic film applied is a PET film, which is suitable for hot lamination, or a OPP film, which is suitable for cold lamination. Other known coatings or lining/laminating films may be considered.

6. The map according to one of the claims from 1. to 5. and wherein the provided laminar map spine (4) is formed at the upper map edge of the map sheet (1) and/or of the separate cover by two parallel grooves (5) and (6) and by two cross folds. Such grooves are embossed perpendicular to the fanfolds and are centered at the upper edge of the map and have an interval of minimum 1 mm and maximum 25 mm from eachother.

7. The map according to one of the claims from 1. to 5. and wherein the provided laminar map spine (4) is formed at the upper map edge of the map sheet (1) is formed with a flat component and by heating up to a wide laminar cross fold, which is heated up to a temperature of 40° C. to 200° C. and cooled down and has a minimum width of 1 mm and a maximum of 25 mm.
